(19) United States
(12) Patent Application Publication
(10) Pub. No.: US 2016/0040714 A1
(43) Pub. Date: Feb. 11, 2016

(54) CAGE FOR INCLINED BALL BEARING

(71) Applicant: Schaeffler Technologies AG & Co. KG, Herzogenaurach (DE)

(72) Inventors: Ralf Heiss, Schweinfurt (DE); Frank Eichelmann, Hassfurt (DE); Felix Gessner, Massbach (DE)

(21) Appl. No.: 14/414,073

(22) PCT Filed: May 28, 2013
(86) PCT No.: PCT/EP2013/060905

§ 371 Date: Apr. 20, 2015

(30) Foreign Application Priority Data
Jul. 11, 2012 (DE) 102012212056.4

(51) Int. Cl. F16C 33/38; F16C 19/16

(52) U.S. Cl. CPC F16C 33/3862; F16C 19/163

(57) ABSTRACT

A rolling bearing cage 10 with two rings 1,2 connected by webs 9, wherein webs 9 provided with bifurcations 8 are used to solve the problem of reducing weight while simultaneously ensuring increased load rating, wherein said webs 9 permit adjacent rolling bodies to be arranged very close to one another. Furthermore, a plurality of identical cages 10 are prevented from tangling in each other when said cages are heaped in large quantities. Overall, the cage 10 allows a more compact design for inclined ball bearings and also reduces their moment of friction.

The present invention relates to a rolling bearing cage for accommodating rolling bodies designed as balls, including two axially opposite rings and webs forming rolling body pockets together with the rings, a first reference circle diameter of the first ring being greater than a second reference circle diameter of the second ring and also being greater than the reference circle diameter of the rolling bodies. In addition, the present invention relates to a rolling bearing, in particular an inclined ball bearing, including one or multiple of these cages.

### BACKGROUND

Such a rolling body cage is present in most cases in inclined ball bearings, for example, in double-row inclined ball bearings. The rolling bearing cage has the task of spacing the ball-shaped rolling bodies situated and guided in it in such a way that a high load rating is possible due to an optimal filling.

Today, inclined ball bearings are, for example, designed to include window cages or snap cages. The window cage (TVP) is provided with two rings situated concentrically to each other, which assume the task of reinforcing the window cage. Webs are formed between the rings which, together with the rings, form ball pockets which are provided for accommodating the balls. The window cage has the advantage that it retains a high stability and may be piled and stored in large quantities, as is generally necessary shortly before rolling bearing assembly, without the window cages interlocking and becoming entangled with each other.

Disadvantageously, due to the double-sided reinforcement via the rings in a window cage, the spacing between adjacent balls may be reduced only up to a lower limit. The minimum spacing between the balls must generally and typically be greater than 0.5 mm, as is the case with wheel bearings designed as double-row inclined ball bearings.

In the past, alternatively to the window cage, snap cages (TVH) were also used, which have only a one-sided reinforcement, but the spacing between the balls may be further minimized and thus a higher degree of ball filling may be achieved. This takes place at the expense of the stability of the cage and also results in a logistics problem, i.e., the entanglement of the rings which are reinforced only on one side in larger aggregations. This generally results in an increased number of rejects, in particular if the cages are delivered as bulk goods. It is then hardly possible to separate them automatically.

Window cages are known, for example, from DE 10 2010 023 521 A1, and snap cages are known from DE 324 79 48 C2.

### SUMMARY OF THE INVENTION

It is an object of the present invention to provide a rolling body cage for an inclined ball bearing which makes a high degree of ball filling possible and avoids the aforementioned disadvantages, at a low cost.

The present invention provides a rolling body cage of the type mentioned at the outset, in that the webs form curved contact surfaces in both circumferential directions and bifurcate at the reference circle of the rolling bodies.

Due to the bifurcation, it is possible for the balls to be opposite each other in the circumferential direction, it being possible to keep the spacing very small, since the cage forms a recess in the area of the reference circle. However, in addition, the cage is provided with two rings as reinforcements, the greatest material accumulation of the webs between the two rings being situated slightly beneath or above the reference circle of the rolling bodies. Advantageously, the cage now has a high degree of filling, but may be reinforced in equal measure by two rings; in other words, it has a stability which is comparable to a window cage. The bifurcation of the webs does not affect the stability properties of the cage, but supports a greater filling of the cage and thus a higher load rating of the rolling bearing.

The webs have the function of connecting both rings to each other and forming the rolling body pockets. Since the rolling bodies are designed as balls, the contact surfaces at the webs must be curved despite the bifurcation. The contact surfaces thus fit snugly against the rolling bodies in an optimal manner.

The reference circle of the rolling bodies is to be understood to be the closed line which interconnects the rolling body centers in the circumferential direction. The center of mass of the rolling body, here, a ball, may be considered to be a rolling body center.

The reference circle of a ring is defined by the points which form the center of the sectional area for any arbitrary longitudinal section along the axis of rotation. Thus, the reference circles of the rings run in the circumferential direction and within them. The reference circle diameter of a ring is thus always greater than its inner diameter and less than its outer diameter.

In one advantageous specific embodiment, the webs form a first, radially outer end and a second, radially inner end on the axial side oriented toward the first ring, via the bifurcation. The bifurcation thus includes the reference circle of the rolling bodies and also forms a recess at this point, which is used to arrange adjacent rolling bodies preferably close to each other.

Advantageously, the first end is connected to the first ring, and the second end is formed as a free end. The free end assumes a holding function, particularly as the first end contributes primarily to the stabilization and is therefore designed to be more solid. Alternatively, both ends may meet again, the recess around the reference circle thus constituting an opening oriented in the circumferential direction, which is completely encompassed by its web. However, the latter specific embodiment requires more material, mostly plastic material.

In addition, it may be advantageous if the bifurcation of the webs is open, oriented axially toward the first ring. In this way, it is possible to save material, and an injection-molding method is also easier to apply if the recess in the bifurcation is open on one side in the axial direction.

For some applications, a contact of the rolling bodies may possibly take place within the bifurcation. However, the friction is best reduced if the rolling bodies are not able to contact each other during operation; for this purpose, the thickness of the webs in the circumferential direction is selected in such a way that adjacent rolling bodies in the area of the bifurcation are directly opposite each other in the circumferential direction without contacting each other.

In one advantageous specific embodiment, the second ends form a reference circle whose reference circle diameter is less than the reference circle diameter of the second ring. Thus, the first end of the web extends radially outwardly around the second end in order for the second end to be protected outwardly. This is in particular advantageous if the cages are piled up in larger quantities. The second ends are thus not reachable by other rolling bearing rings and are not able to become entangled with them. Thus, logistics problems or rejects do not occur.

The first ring may have recesses which are at least partially directed radially inwardly, which also form the rolling body pockets. The positioning of the first ring is thus optimized in comparison to the rolling body pockets or to the second ring, since the rolling body gap may also be partially used. In addition, this results in a reduction of the axial width of the cage, making it possible to arrange rolling body rows of the inclined ball bearing very close to each other in the axial direction.

The axial width of the cage may be further reduced by the second ring delimiting the rolling bearing cage axially on one side in combination with the first ring, which rather delimits radially with respect to the rolling bodies. In other words, the second ring delimits the rolling body pockets almost exclusively axially, the first ring delimiting the rolling body pockets from the axial and radial directions.

Rolling ball bearings, in particular inclined ball bearings, which use a cage according to the present invention, have an advantageously small axial width at a high load rating, exactly like the cage.

Additional advantageous embodiments and preferred refinements of the present invention may be inferred from the description of the figures.

The present invention is described and illustrated in greater detail below based on the exemplary embodiments depicted in the figures.

### BRIEF DESCRIPTION OF THE DRAWINGS

FIG. 1 shows a rolling bearing cage for an inclined ball bearing, and

FIG. 2 shows a section of the cage shown in FIG. 1.

### DETAILED DESCRIPTION

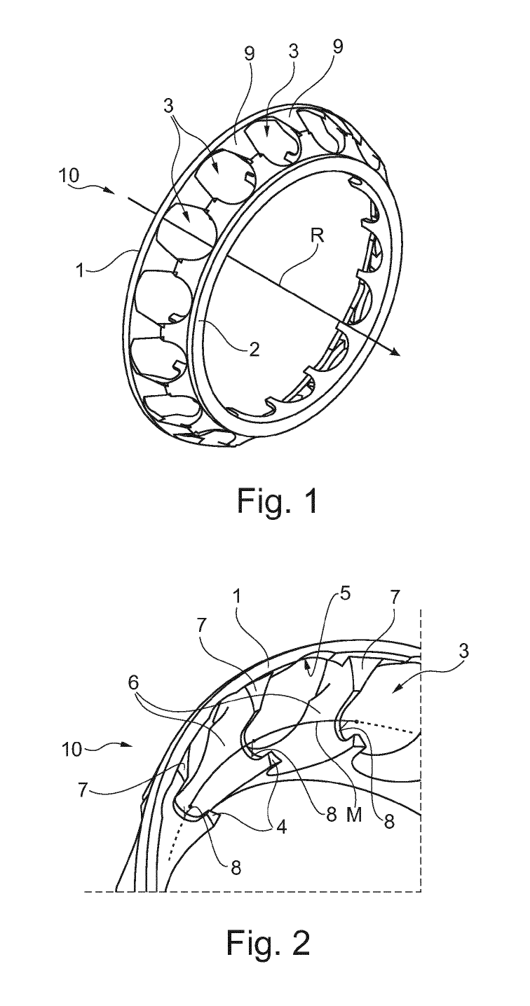

FIG. 1 shows an inclined ball bearing cage 10 including its axis of rotation R. Ball pockets 3 are separated by webs 9, webs 9 also connecting rings 1, 2 to each other and ensuring a sufficient stability.

FIG. 2 shows a section of inclined ball bearing cage 10, the areas around bifurcations 8 of three webs 9 being more clearly apparent. Free ends 4, together with first ends 7 of webs 9, form required bifurcation 8. Bifurcations 8 are open in the axial direction, oriented toward first ring 1. This characteristic results in the logistical advantage that cages having identical dimensions may be stacked into each other, second ring 2 of a cage being enclosed in bifurcations 8 of the adjacent cage.

In addition, the rings are in any case designed in such a way that they are not able to become entangled with each other and are thus easy to separate. This characteristic is based essentially on the design of first ring 1.

Rolling body pockets 3 largely fit snugly against a ball-shaped rolling body, which is not depicted. This is achieved by contact surfaces 6 of webs 9, and also by recess 5 on first ring 1. As a result, it is possible to arrange outer, first ring 1 both radially and axially and thus, if cage 10 is filled, does not project axially beyond the balls, which are not depicted, whereby an installation space advantage in the axial direction may be achieved.

In addition, recesses 5 may be designed in such a way that the ball retention force is also determinable or controllable due to the rigidity. This retention force is necessary in order to retain the rolling bodies in cage 10 after being snapped into place, and thus constitutes an assembly advantage. Ring 1 reinforces rolling body pockets 3 and thus increases the advantageous retention force.

Ends 4 and 7 may alternatively also be connected to each other, bifurcation 8 forming a recess which is completely encompassed by web 9. Although such a cage is difficult to manufacture, it would be easier to handle if cages having different diameters were to be piled together.

Because of bifurcation 8 or the recess, rolling body pocket 3 is designed in such a way that it comes into contact with the rolling body only at the necessary points. The friction moment is thus considerably reduced.

In summary, the present invention relates to a rolling bearing cage 10 including two rings 1, 2 connected to two webs 9, webs 9 provided with bifurcations 8 being used to achieve the object, namely reducing weight at a simultaneously increased load rating, webs 9 allowing adjacent rolling bodies to be arranged very close to each other. Furthermore, an entanglement of multiple structurally identical cages 10 is avoided if they are piled up in large quantities. Overall, cage 10 allows a more compact design for inclined ball bearings and in addition reduces their friction moment.

### LIST OF REFERENCE NUMERALS

1 first, outer ring
2 second, inner ring
3 rolling body pockets
4 second, free end
5 recess
6 contact surface
7 first end
8 bifurcation
9 web
10 inclined ball bearing cage
R axis of rotation
M reference circle of the rolling bodies

1-9. (canceled)

10: A rolling bearing cage for accommodating rolling bodies designed as balls, the rolling bearing cage comprising:
axially opposite first and second rings; and
webs forming rolling body pockets together with the rings, a first reference circle diameter of the first ring being greater than a second reference circle diameter of the second ring and also being greater than a diameter of a reference circle of the rolling bodies, the webs forming curved contact surfaces in both circumferential directions and bifurcate at the reference circle of the rolling bodies.

11: The rolling bearing cage as recited in claim 10 wherein the webs form a first, radially outer end and a second, radially free end on the axial side oriented toward the first ring, via the bifurcation.

12: The rolling bearing cage as recited in claim 11 wherein the first end is connected to the first ring, and the second end is formed as a free end.

13: The rolling bearing cage as recited in claim 11 wherein the bifurcation of the webs is open, oriented axially toward the first ring.

14: The rolling bearing cage as recited in claim 11 wherein the thickness of the webs in the circumferential direction is selected in such a way that adjacent rolling bodies in the area of the bifurcation are directly opposite each other in the circumferential direction, but are not able to contact each other during the operation of the rolling bearing.

15: The rolling bearing cage as recited in claim 11 wherein the second ends form a reference circle whose reference circle diameter is less than the reference circle diameter of the reference circle of the second ring.

16: The rolling bearing cage as recited in claim 11 wherein the first ring has recesses at least partially directed radially inwardly and also forming the rolling body pockets.

17: The rolling bearing cage as recited in claim 11 wherein the second ring delimits the rolling bearing cage axially on one side.

18: A rolling bearing comprising the rolling bearing cage as recited in claim 11.

19: An inclined ball bearing comprising the rolling bearing cage as recited in claim 11.
